(19) United States
(12) Patent Application Publication
(10) Pub. No.: US 2003/0075154 A1
(43) Pub. Date: Apr. 24, 2003

(54) Fuel-injection system for internal combustion engines

(76) Inventors: Detlev Potz, Stuttgart (DE); Thomas Kuegler, Muenchingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/169,713

(22) PCT Filed: Nov. 17, 2001
(86) PCT No.: PCT/DE01/04337

(30) Foreign Application Priority Data
Nov. 22, 2000 (DE) 100-58-130.7

(51) Int. Cl. F02M 1/00

(52) U.S. Cl. 123/456; 123/467

(57) ABSTRACT

A fuel injection system for internal combustion engines, having a high-pressure accumulation chamber (7), which contains high-pressure fuel, having at least one fuel injection valve (15), which is connected to the high-pressure accumulation chamber (7). The fuel injection valve (15) can inject the highly pressurized fuel through injection openings (41, 42) into a combustion chamber of the engine. The fuel injection valve (15) has a control chamber (62), which is defined by a longitudinally mobile piston (60) and is operationally connected to the fuel injection valve (15) so that the injection cross section of the fuel injection valve (15) is controlled as a function of the hydraulic pressure in the control chamber (62). A low-pressure accumulation chamber (72) is provided, which can be connected to the control chamber (62), in which a predetermined fuel pressure is maintained in the low-pressure accumulation chamber (72) that is lower than the pressure in the high-pressure accumulation chamber (7) (FIG. 1).

### PRIOR ART

The invention is based on a fuel injection system for internal combustion engines as has been disclosed by the patent application DE 41 15 477 A1. This reference discloses a fuel injection system that includes a fuel injection valve that has a valve body. The valve body contains a bore in which a hollow needle is guided. The hollow needle has a pressure shoulder and at the level of this pressure shoulder, is encompassed by a pressure chamber, which is formed by a radial expansion of the bore and communicates with a high-pressure fuel source. At its combustion chamber end, the hollow needle has a sealing surface, which rests against a valve seat embodied at the combustion chamber end of the bore. A spring exerts a closing force on the hollow needle in the direction of the valve seat and when the pressure chamber is not pressurized, the hollow needle remains in the closed position in which it closes a first row of injection openings disposed in the valve seat. An internal needle is guided inside the hollow needle and also has a sealing surface at its combustion chamber end and rests against the valve seat. The internal needle here is likewise pressed toward the valve seat by a spring and thus, when no injection of fuel is to take place, remains in contact with the valve seat, thus closing a second row of injection openings that are likewise disposed in the valve seat and are situated downstream of the first row of injection openings. At its end oriented away from the combustion chamber, the internal needle transitions into a piston rod, which connects the internal needle axially to a piston, which defines a control chamber in such a way that through a corresponding pressure in the control chamber, a force in the closing direction can be exerted on the piston and therefore via the piston rod, on the internal needle as well. An adjusting device can be used to convey the fuel, which is conveyed into the pressure chamber in the case of an injection, also into the control chamber so that a high fuel pressure prevails there. If this is the case, then the internal needle is acted on by a high pressure in the closing direction so that due to the fuel pressure in the pressure chamber, the force on the pressure surface moves only the hollow needle in the opening direction, counter to the closing force, and unblocks the first row of injection openings. The high fuel pressure of the pressure chamber does in fact then act on a pressure surface embodied at the combustion chamber end of the internal needle, but this hydraulic opening pressure counteracts the hydraulic force of the control chamber so that the internal needle remains in the closed position. Since only a portion of the injection openings is opened in this operational mode, an injection with a small cross section is produced so that only a small quantity is injected, but with an appropriately high fuel pressure. If an injection is to take place with the entire injection cross section, then the control device closes off the control chamber from the high-pressure line so that it is pressure-relieved into a leakage fuel chamber. Now only the weaker force of the closing spring is acting on the internal needle so that with a correspondingly high pressure in the pressure chamber, first the hollow needle travels into the open position and then, due to the hydraulic force on the pressure surface, the internal needle also travels into the open position, thus unblocking the second row of injection openings.

The known fuel injection system, however, has the disadvantage that only the high pressure that is also used for the injection is available for use as the control pressure. As a result, the control chamber and all of the lines leading to it, as well as the adjusting device, must be correspondingly embodied to be suitable for high pressure. In the injection systems that are common today, which use a high-pressure accumulation chamber, a so-called “common rail”, some injection pressures are considerably higher than 100 MPa so that high demands are placed on the mechanics of the adjusting device, the control chamber, and the piston guided therein, which makes these devices complex and correspondingly costly. In addition, pump losses occur during the pressure relief of the control chamber. Moreover, a control valve for the pressure in the control chamber must be provided for each injection valve.

### ADVANTAGES OF THE INVENTION

The fuel injection system according to the invention, with the characterizing features of claim 1, has the advantage over the prior art that each fuel injection valve of the fuel injection system has a control chamber, which can be connected to a low-pressure accumulation chamber. The control chamber is defined by a piston, which depending on the pressure in the control chamber, controls the injection cross section of the fuel injection valve so that the injection cross section can be controlled via the connection of the low-pressure accumulation chamber to the control chamber by means of a pressure that is lower than the pressure in the high-pressure accumulation chamber.

In an advantageous embodiment of the subject of the invention, the low-pressure accumulation chamber is supplied with fuel by means of the fuel pressure in the fuel injection valve. In this case, a high-pressure valve embodied as a 3/2-port directional-control valve is disposed between the high-pressure accumulation chamber that furnishes the fuel with injection pressure, the fuel injection valve, and the low-pressure accumulation chamber. In a first position, the high-pressure valve connects the pressure chamber embodied in the valve body to the low-pressure accumulation chamber while the connection to the high-pressure accumulation chamber is closed off. In a second position of the high-pressure valve, the high-pressure accumulation chamber is connected to the pressure chamber of the fuel injection valve while the connection to the low-pressure accumulation chamber is closed off. During an injection, the full injection pressure of the high-pressure accumulation chamber prevails in the pressure chamber, i.e. the high-pressure valve is disposed in its second position. If the injection is to be terminated, the high-pressure valve switches and the highly pressurized fuel in the pressure chamber is pressure-relieved into the low-pressure accumulation chamber. By means of this, a fuel pressure is built up there, which is kept to a predetermined level by means of a pressure-holding valve. In this way, a predetermined fuel pressure level can be maintained in the low-pressure accumulation chamber without requiring a separate pressure source, for example in the form of an additional fuel pump.

In another advantageous embodiment of the subject of the invention, a control valve can feed the pressure of the low-pressure accumulation chamber into the control chamber or the control chamber can be pressure-relieved into a fuel tank. Because of the relatively low pressure in the low-pressure accumulation chamber, the control valve that controls the control chamber can be embodied as a low-pressure valve, which is much less costly than a control valve for very high fuel pressures. It is also sufficient if all of the lines from the low-pressure accumulation chamber are merely designed to function at this low pressure. In the same way, the control chamber and the piston guided in it can be produced in a correspondingly inexpensive manner.

In another advantageous embodiment of the subject of the invention, a pressure-holding valve is disposed in the leakage fuel line that can connect the low-pressure valve to the control chamber. In this manner, the control chamber is always kept at a certain fuel pressure, but one that is lower than the pressure in the low-pressure accumulation chamber. This residual pressure in the control chamber can function as a so-called oil spring, which continuously exerts a closing force on the corresponding valve needle by means of the hydraulic force on the piston. This permits the elimination of a closing spring, which is normally required to continuously exert a closing force on the valve needle that is connected to the piston.

Other advantages and advantageous embodiments of the subject of the invention can be inferred from the specification, the drawings, and the claims.

### DRAWINGS

An exemplary embodiment of the fuel injection system according to the invention is shown in the drawings.

FIG. 1 shows a schematic design of a fuel injection system, together with a longitudinal section through a fuel injection valve,

FIG. 2 is an enlarged depiction in the seat region of the fuel injection valve, and

FIG. 3 is an enlarged depiction of another exemplary embodiment of the fuel injection system in the vicinity of the low-pressure valve.

### DESCRIPTION OF THE EXEMPLARY EMBODIMENT

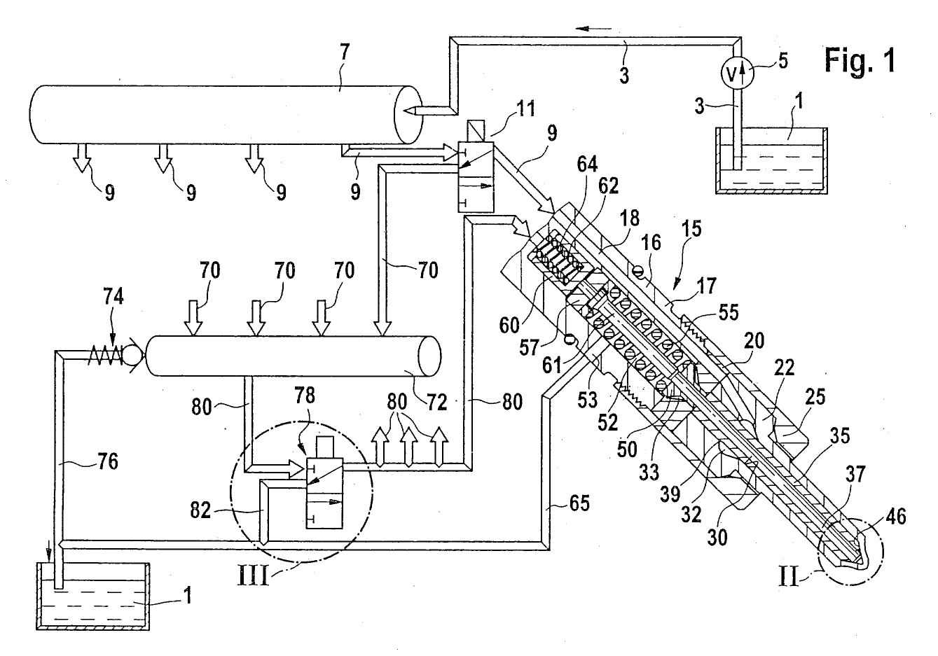

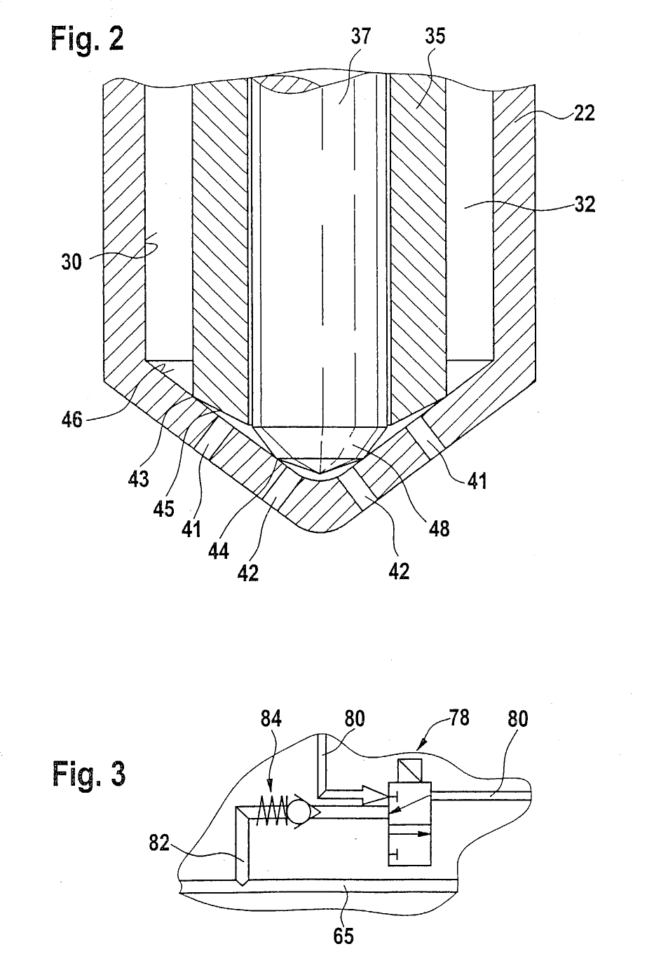

FIG. 1 gives a schematic depiction of a fuel injection system for internal combustion engines, in which a fuel injection valve 15 is shown in a longitudinal section and the remaining components of the fuel injection system are schematically depicted. Fuel is supplied from a fuel tank 1 via a fuel line 3 to a high-pressure pump 5, which sends it further via the fuel line 3 to a high-pressure accumulation chamber 7. A control device that is not shown in the drawing assures that a predetermined high fuel pressure level is maintained at all times in the high-pressure accumulation chamber 7. High-pressure lines 9 lead from the high-pressure accumulation chamber 7 and can each be connected to a fuel injection valve 15. Only one of these fuel injection valves 15 is shown in FIG. 1. The high-pressure line 9 is connected to a high-pressure valve 11, which is embodied as a 3/2-port directional-control valve. From the high-pressure valve 11, the high-pressure line 9 continues to the fuel injection valve 15. The fuel injection valve 15 has a housing 16, which is comprised of a valve holding body 17, an intermediary disc 20, and a valve body 22; a retaining nut 25 secures the valve body 22 axially against the valve holding body 17 with the interposition of the intermediary disc 20. The valve body 22 contains a bore 30 in which a valve needle in the form of a hollow needle 35 is guided in a longitudinally mobile fashion. At the combustion chamber end of the bore 30, there is a valve seat 46 in which two rows of injection openings 41, 42 are provided, which are offset from each other in the axial direction. One row of injection openings 41, 42 here is comprised of a number of injection openings, which are preferably distributed uniformly over the circumference of the valve body 22. FIG. 2 shows an enlarged depiction of FIG. 1 in the vicinity of the valve seat 46. The hollow needle 35 is guided in a sealed fashion in a section of the bore 30 remote from the combustion chamber and tapers toward the combustion chamber forming a pressure shoulder 39, which serves as a pressure surface. At the combustion chamber end, the hollow needle 35 transitions into an outer sealing surface 45, which is essentially embodied as conical, so that at the transition from the outer circumference surface of the hollow needle 35 to the sealing surface 45, an outer sealing edge 43 is formed, which rests against the valve seat 46 in the closed position of the hollow needle 35. At the level of the pressure shoulder 39, a radial expansion of the bore 30 in the valve body 22 constitutes a pressure chamber 32, which encompasses the hollow needle 35 and extends to the valve seat 46. By means of a supply conduit 18, which extends in the valve body 22, intermediary disc 20, and valve holding body 17, and by means of the high-pressure line 9, the pressure chamber 32 can be connected to the high-pressure accumulation chamber 7. The first row of injection openings 41 in the valve seat 46 is situated so that the sealing edge 43 of the hollow needle 35 closes the first row of injection openings 41 off from the pressure chamber 32, which means that no fuel is injected when the hollow needle 35 is in contact with the valve seat 46.

At its end oriented away from the combustion chamber, the hollow needle 35 rests against a spring plate 50, which is disposed in a central opening 33 embodied in the intermediary disc 20. At the transition of the valve body 22 into the intermediary disc 20, the central opening 33 here has a smaller diameter than the bore 30 so that a stop shoulder is formed on the intermediary disc 20, which functions as a stroke limiting stop for the hollow needle 35 during its opening stroke motion. The spring plate 33 protrudes into a spring chamber 52 embodied in the valve holding body 17, which contains a closing spring 55 under a compressive initial stress. In this case, the closing spring 55 rests against a support ring 57 at its end oriented away from the combustion chamber and rests against the spring plate 50 at its end oriented toward the combustion chamber so that the initial stress of the closing spring 55 exerts a closing force on the hollow needle 35 in the direction of the valve seat 46. The spring chamber 52 has a leakage fuel connection 53 to which a leakage fuel line 65 is connected so that the spring chamber 52 continually communicates with the fuel tank 1 and is therefore not pressurized.

A valve needle in the form of an internal needle 37 is guided in a longitudinally mobile fashion inside the hollow needle 35 and at its end oriented toward the combustion chamber, has a conical pressure surface 48, which is bounded by a sealing edge 44. In the closed position of the internal needle 37, the sealing edge 44 rests against the valve seat 46 and thus closes the second row of injection openings 42 off from the pressure chamber 32. At its end oriented away from the combustion chamber, the internal needle 37 transitions into a piston rod 61, which protrudes through the spring plate 50 and the spring chamber 52 into a control chamber 62, which is embodied in the valve holding body 17 at its end further away from the combustion chamber than the spring chamber 52. The control chamber 62 contains a movable piston 60, which is guided in a sealed fashion in the control chamber 62 and is bowl-shaped. The piston 60 is connected to the piston rod 61 so that it moves in the longitudinal direction synchronously with the internal needle 37. The control chamber 62 contains a closing spring 64, which has a compressive initial stress and acts on the internal needle 37 in the closing direction in addition to the hydraulic force that is exerted by the pressure prevailing in the control chamber 62.

In addition, the fuel injection system has a low-pressure accumulation chamber 72 in which a predetermined fuel pressure level is maintained, which is significantly lower than the fuel pressure level of the high-pressure accumulation chamber 7. For example, a pressure prevails in the low-pressure accumulation chamber 72 that is at most approximately one fifth of the pressure in the high-pressure accumulation chamber 7, which can be more than 100 MPa. A diversion line 70 leads from each high-pressure valve 11 to the low-pressure accumulation chamber 72 so that the high-pressure line 9 from the high-pressure accumulation chamber 7, the high-pressure line 9 to the fuel injection valve 15, and the diversion line 70 are either connected to each other or closed off from each other by the 3/2-port directional-control valve function of the high-pressure valve 11. The high-pressure valve 11 can be switched into two switching positions. In the first position, which is shown in FIG. 1, the high-pressure valve 11 connects the high-pressure line 9 coming from the pressure chamber 32 of the fuel injection valve 15 to the diversion line 70, while the connection to the high-pressure accumulation chamber 7 is closed off. In the second position of the high-pressure valve 11, the high-pressure accumulation chamber 7 is connected via the high-pressure line 9 to the pressure chamber 32 of the fuel injection valve 15, while the diversion line 70 is closed off. The first position of the high-pressure valve 11 corresponds to the position in which no fuel is to be injected into the combustion chamber of the internal combustion engine, whereas the second position is selected during the injection of fuel.

The low-pressure accumulation chamber 72 is connected via a leakage fuel line 76 to the fuel tank 1; a pressure-holding valve 74 is disposed in the leakage fuel line 76 so that a predetermined fuel pressure level is maintained at all times in the low-pressure accumulation chamber 72. A control line 80 leads from the low-pressure accumulation chamber 72 to a low-pressure valve 78, which is embodied as a 3/2-port directional-control valve. Downstream of a low-pressure valve 78, the control line 80 splits in accordance with the number of fuel injection valves and feeds into the control chamber 62 of each respective fuel injection valve 15. A leakage fuel line 82 connected to the fuel tank 1 also leads to the low-pressure valve 78. In the first position of the low-pressure valve 78, which is shown in FIG. 1, the control line 80 coming from the control chamber 62 is connected to the leakage fuel line 82 while the control line 80 coming from the low-pressure accumulation chamber 72 is closed. As a result, the control chamber 62 is connected to the fuel tank 1 and is therefore switched into an unpressurized state. In the second position of a low-pressure valve 78, the low-pressure accumulation chamber 72 is connected to the control chamber 62 via the control line 80 while the leakage fuel line 82 is closed. As a result, the fuel pressure on the low-pressure accumulation chamber 72 prevails in the control chamber 62. In the fuel injection system according to the invention, a high-pressure valve 11 must be provided for each fuel injection valve 15, but only one low-pressure valve 78 is required for the entire fuel injection system.

The fuel injection system functions as follows: when the internal combustion engine is operated under partial load, only a relatively small amount of fuel is injected into the combustion chamber of the engine. At the given injection pressure, therefore, only a part of the entire injection cross section should be opened. To this end, the low-pressure valve 78 is switched into the second position so that the low-pressure accumulation chamber 72 is connected to the control chamber 62 of each of the fuel injection valves 15 so that a hydraulic force on the piston 60 is exerted and the piston rod 61 and thereby the internal needle 37 are pressed into the closed position. At the onset of injection, the high-pressure valve 11 is switched into the second position so that the high-pressure accumulation chamber 7 is connected to the pressure chamber 32 via the high-pressure line 9 and the supply conduit 18. As a result, highly pressurized fuel flows into the pressure chamber 32 and exerts a hydraulic force on the pressure shoulder 39 of the hollow needle 35. As soon as this hydraulic force on the pressure shoulder 39 exceeds the force of the closing spring 55, the hollow needle 35 moves away from the valve seat 46 and lifts its sealing edge 43 up from the valve seat 46. As a result, the pressure chamber 32 is connected to the first row of injection openings 41 and fuel is injected through them into the combustion chamber of the engine. Since at this point, the fuel pressure is also exerted on the pressure surface 48, a hydraulic force is also exerted on the internal needle 37 in the opening direction. However, the fuel pressure in the control chamber 62 compensates for this hydraulic force so that the internal needle 37 remains in the closed position. If the injection is to be terminated, the high-pressure valve 11 is switched back into the first position so that the connection to the high-pressure accumulation chamber 7 is closed. The pressure chamber 32 is now connected via the supply conduit 18 and the high-pressure line 9 to the diversion line 70 and therefore to the low-pressure accumulation chamber 72. The residual pressure in the pressure chamber 32 is now pressure-relieved into the low-pressure accumulation chamber 72 so that a diversion flow into the low-pressure chamber 72 is produced, which increases the fuel pressure therein. As soon as the fuel pressure in the low-pressure accumulation chamber 72 exceeds a predetermined level, the pressure-holding valve 74 opens and fuel flows out of the low-pressure accumulation chamber 72 back into the fuel tank 1. Because of the currently falling pressure in the pressure chamber 32, the hydraulic force on the pressure shoulder 39 also decreases and, due to the force of the closing spring 55, the hollow needle 35 is pressed back into the closed position and the injection openings 41 are closed once more. The leakage fuel flows, which are caused by the high-pressure difference between the pressure chamber 32 and the spring chamber 52 and which flow toward the spring chamber 52, are carried away by the leakage fuel line 65 so that the fuel pressure level of the fuel tank 1 is maintained in the spring chamber 52. If the internal combustion engine is to be operated at full load, then both rows of injection openings 41, 42 are opened. To this end, the low-pressure valve 78 is switched into the first position so that the control chamber 62 is now pressure-relieved via the control line 80 and the leakage fuel line 82. The first part of the injection occurs as described above in connection with the partial load operation but now, after the hollow needle 35 is moved into the open position, the exertion of pressure on the pressure surface 48 also moves the internal needle 37 into the open position so that the second row of injection openings 42 is also unblocked and fuel from the pressure chamber 32 is injected through the entire injection cross section. In this operational mode, only the force of the closing spring 64 is exerted on the internal needle 37 so that the hydraulic pressure on the pressure surface 48 is now sufficient to produce an opening stroke motion. The end of the injection takes place as described above through the switching of the high-pressure valve 11.

FIG. 3 shows another exemplary embodiment of the fuel injection system; in this instance, only a detail in the vicinity of the low-pressure valve 78 is depicted. The low-pressure valve 78 in this exemplary embodiment functions the same way as in the exemplary embodiment shown in FIG. 1, but in this instance, a pressure-holding valve 84 is disposed in the leakage fuel line 82. In the first position of the low-pressure valve 78, which is shown in FIG. 3, the control chamber 62 is not completely pressure-relieved, but instead, a residual pressure remains, which is determined by the pressure-holding valve 84. Through a suitable design, this hydraulic residual pressure can exert a force on the piston 60, which corresponds to the force of the closing spring 64 so that the closing spring 64 can be eliminated. Therefore a so-called oil spring is used in lieu of the closing spring 64.

The low-pressure accumulation chamber 72 is supplied with fuel at a sufficient pressure exclusively by means of the diversion flow from the fuel injection valves 15. An additional fuel pressure source, for example in the form of an additional fuel pump, can therefore be eliminated. Since all of the fuel injection valves 15 of the internal combustion engine are connected to the low-pressure accumulation chamber 72, the operational mode, i.e. partial load operation or full load operation, can be set synchronously for all of the fuel injection valves 15 through a corresponding switching of the low-pressure valve 78.

1. A fuel injection system for internal combustion engines, having a high-pressure accumulation chamber (7), which contains highly pressurized fuel, and having at least one fuel injection valve (15), which is connected to the high-pressure accumulation chamber (7) and can inject the highly pressurized fuel through injection openings (41, 42), which constitute an injection cross section, into a combustion chamber of the engine, and having a control chamber (62), which is defined by a longitudinally mobile piston (60) and is operationally connected to the fuel injection valve (15) so that the injection cross section of the fuel injection valve (15) is controlled as a function of the hydraulic pressure in the control chamber (62), characterized in that a low-pressure accumulation chamber (72) can be connected to the control chamber (62), in which a predetermined fuel pressure is maintained in the low-pressure accumulation chamber (72) that is lower than the pressure in the high-pressure accumulation chamber (7).

2. The fuel injection system according to claim 1, characterized in that more than one fuel injection valve (15) is provided in the fuel injection system, in which each fuel injection valve (15) is provided with a control chamber (62), which is connected to the low-pressure accumulation chamber (72).

3. The fuel injection system according to claim 1, characterized in that in order to control the injection openings (41; 42), at least one valve needle (35; 37) is disposed so that it can move longitudinally in a bore (30) of the fuel injection valve (15), counter to a closing force, and has a pressure surface (39; 48), which is disposed in a pressure chamber (32) that can be connected to the high-pressure accumulation chamber (7) so that the pressure in the pressure chamber (32) can move the valve needle (35; 37) longitudinally, counter to the closing force, in which the valve needle (35; 37) is connected to the piston (60).

4. The fuel injection system according to claim 3, characterized in that two valve needles (35; 37) are disposed in the fuel injection valve (15), in which one valve needle is embodied as a hollow needle (35) and one valve needle is embodied as an internal needle (37) guided inside the hollow needle (35), in which one of the valve needles (35; 37) is connected to the piston (60).

5. The fuel injection system according to claim 4, characterized in that the hollow needle (35) and the internal needle (37) each control only a portion of the injection openings (41, 42).

6. The fuel injection system according to claim 4, characterized in that one valve needle (35; 37) is connected to the piston (60) by means of a piston rod (61).

7. The fuel injection system according to claim 3, characterized in that the high-pressure accumulation chamber (7), the low-pressure accumulation chamber (72), and the pressure chamber (32) are connected to a high-pressure valve (11) so that in a first position of the high-pressure valve (11), the high-pressure accumulation chamber (7) is connected to the pressure chamber (32) while the connection to the low-pressure accumulation chamber (72) is closed off, and in a second position of the high-pressure valve (11), the low-pressure accumulation chamber (72) is connected to the pressure chamber (32), while the connection to the high-pressure accumulation chamber (7) is closed off.

8. The fuel injection system according to claim 1, characterized in that the low-pressure accumulation chamber (72), an unpressurized fuel tank (1), and the control chamber (62) are connected by means of a low-pressure valve (78) so that in a first position of the low-pressure valve (78), the fuel tank (1) is connected to the control chamber (62) while the connection to the low-pressure accumulation chamber (72) is closed off, and in a second position of the low-pressure valve (78), the low-pressure accumulation chamber (72) is connected to the control chamber (62) while the connection to the fuel tank (1) is closed off.

9. The fuel injection system according to claim 8, characterized in that the fuel tank (1) is connected to the low-pressure valve (78) via a leakage fuel line (82) and a pressure-holding valve (84) is disposed in the leakage fuel line (82) so that in the first position of the low-pressure valve (78), the fuel pressure in the control chamber (62) does not exceed a predetermined pressure.

10. The fuel injection system according to claim 1, characterized in that the low-pressure accumulation chamber (72) is connected to the fuel tank (1) via a pressure-holding valve (74) so that a predetermined pressure level in the low-pressure accumulation chamber (72) is not exceeded.

11. The fuel injection system according to claim 10, characterized in that the fuel pressure in the low-pressure accumulation chamber (72) is always less than approximately one fifth of the fuel pressure in the high-pressure accumulation chamber (7).
